(19) United States
(12) Patent Application Publication
(10) Pub. No.: US 2005/0050238 A1
(43) Pub. Date: Mar. 3, 2005

(54) Computer system for dynamically accessing externally connecting storage devices

(76) Inventor: Chih-Wei Chen, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/650,430

(22) Filed: Aug. 28, 2003

(51) Int. Cl. G06F 3/00

(52) U.S. Cl. 710/15

(57) ABSTRACT

A computer system for dynamically accessing externally connecting storage devices is provided, which is connected with or separated one or more of the storage devices via a hot plug connection. The computer system includes a connection interface, an I/O control circuit, a system control circuit, an interface control circuit, and a central processing unit. The central processing unit determines whether the connection status between the storage devices and the I/O control circuit has changed, and, if so, executes an interrupt service sequence. During the interrupt service, the central processing unit loads the corresponding interface settings into the interface control circuit for accessing the storage devices according to the current number of connected storage devices and their corresponding configuration association.

### BACKGROUND OF THE INVENTION

1. Field of the Invention

The invention relates to a technique used to connect and access an externally connecting storage device connected with a computer system, and, more particularly, to a computer system that uses a hot plug connection to dynamically connect/separate the storage device.

2. Description of the Related Art

In the present era of information technology, the amount of information processed and communicated by a computer system has rapidly increased. Along with the unceasing demand for larger capacity of information storage, the computer system usually must be adaptable to replacement, upgrade, and extension of storage devices (such as disk drives).

FIG. 1 is a schematic diagram illustrating a computer system structure known in the art. As shown, a hard disk drive 10 is connected via an interface connecting port 100 to an interface bus 12 for sequentially communicating with a central processing unit 14 and an operating system 16. The hard disk drive 10 is further connected via a power connecting port 102 to a power supply 18. When the replacement or addition of another hard disk drive 10 is to be effected, the computer system usually has to be restarted. When several hard disk drives 10 are already installed and the user desires to remove one of them, the computer system similarly has to be restarted to allow the operating system to properly identify and allocate power to the hard disk drive(s) 10. Since the traditional computer system is incapable of providing a hot plug connection for a storage device of large capacity, an inconvenient manipulation is needed by the user who wants to change or expand hard disk drives 10.

### SUMMARY OF THE INVENTION

It is therefore an objective of the invention to provide a computer system that can dynamically access externally connecting storage devices, using hot plug connections for storage devices of large capacity. The user therefore can conveniently replace, upgrade, or expand storage devices of large capacity.

To achieve the above and other objectives, the computer system of the invention, being capable of dynamically connecting with and separating from one or more externally connecting storage devices via hot plug connections, comprises the following elements: a connection interface connected with one or more externally connecting storage devices; an I/O control circuit, to/from which the externally connecting storage device can be either connected or separated wherein the control circuit emits an informing signal when the connection status of an externally connecting storage device changes; a system control circuit connected with the I/O control circuit which receives the informing signal and accordingly outputs an interrupt request signal; an interface control circuit connected with the connection interface which according to its internally stored interface settings, controls the transmission format and the interface format of the connection interface; and a central processing unit connected via the connection interface to the externally connecting storage devices which is used to access the externally connecting storage device, the central processing unit being connected with the system control circuit to receive the interrupt request signal and to execute an interrupt service sequence.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief description of the drawings is as follows:

FIG. 1 (PRIOR ART) is a schematic diagram illustrating a conventional computer system structure;

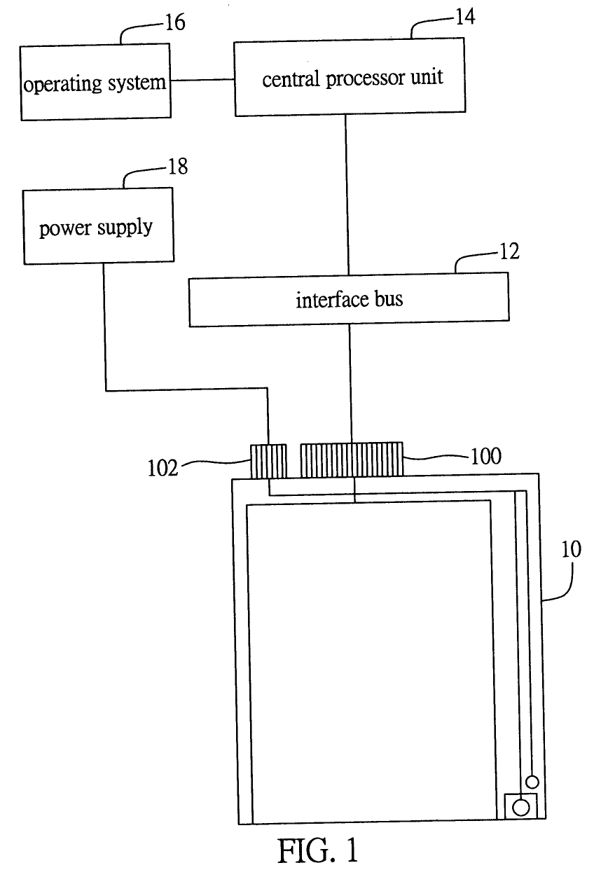

FIG. 2 is a schematic diagram illustrating a computer system structure according to an embodiment of the invention; and

FIG. 3 is a flow chart illustrating an interrupt service sequence implemented according to an embodiment of the invention.

### DETAILED DESCRIPTION OF THE PREFERRED EMBODIMENTS

Wherever possible in the following description, like reference numerals will refer to like elements and parts unless otherwise illustrated.

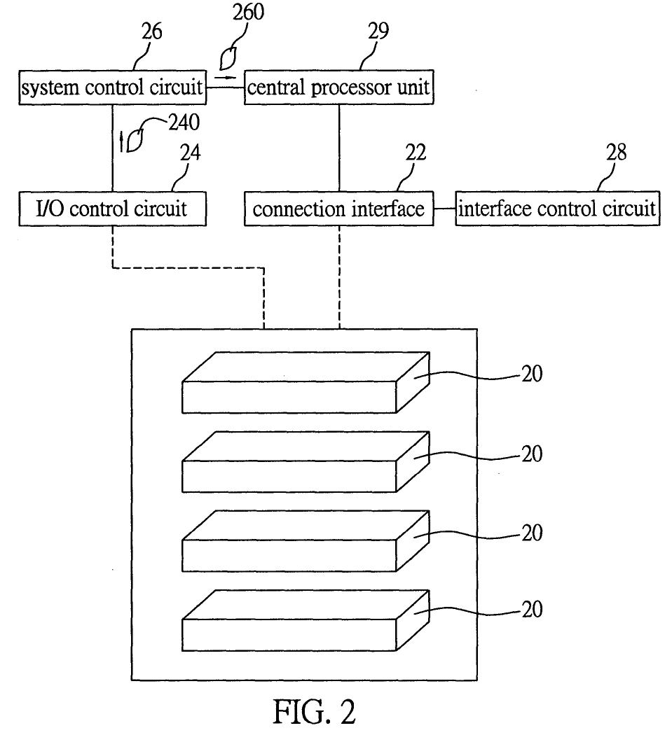

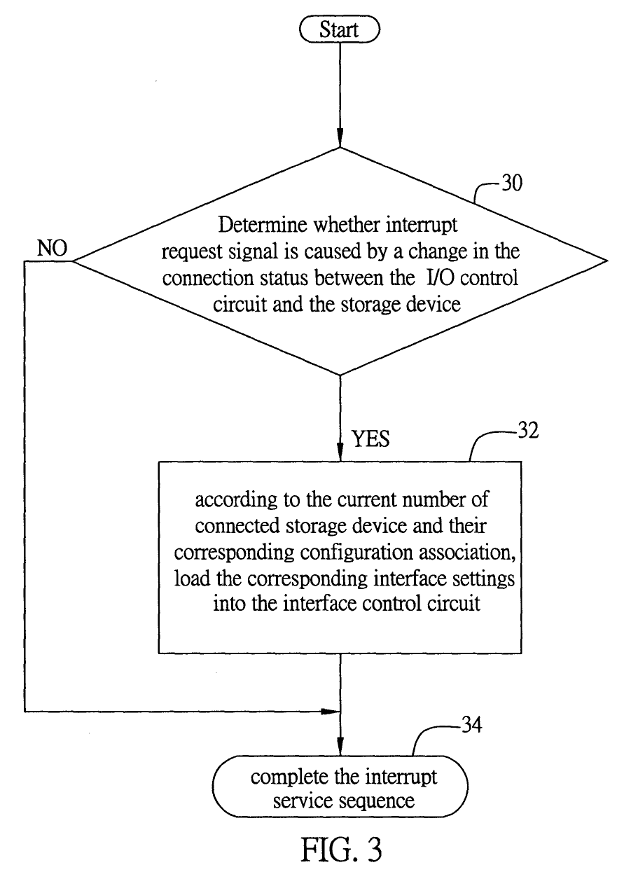

FIG. 2 is a schematic diagram illustrating a computer system structure according to an embodiment of the invention. As illustrated, a computer system according to an embodiment of the invention is capable of dynamically connecting with and separating from, via hot plug connections, one or more externally connecting storage devices 20. In the figure, the dashed lines represent the dynamic connection/separation of each externally connecting storage devices 20 with/from both the connection interface 22 and the input/output (I/O) control circuit 24. The computer system of the invention at least includes a connection interface 22 connected to an externally connecting storage device 20. An I/O control circuit 24, to/from which the externally connecting storage devices 20 can be either connected or separated, is provided to generate an informing signal 240 when the connection status of an externally connecting storage device 20 changes. A system control circuit 26 is connected with the I/O control circuit 24, and receives the informing signal 240 and accordingly outputs an interrupt request signal 260. An interface control circuit 28 is connected with the connection interface 22, which, according to its internally stored interface settings, controls the transmission format and the interface format of the connection interface 22. A central processing unit 29 is connected via the connection interface 22 to the externally connecting storage devices 20, and is used to dynamically access the externally connecting storage devices 20. The central processing unit 29 is further connected with system control circuit 26 to receive the interrupt request signal 260 and consequently execute an interrupt service sequence (shown in FIG. 3).

According to an embodiment of the invention, the computer system of FIG. 2 may be, for example, a storage server system used to principally store a great amount of data. The externally connecting storage device 20 may be, accordingly, a storage device of large capacity such as a storage disc drive. The connection interface 22 used by the storage server system may be, for example, a disk drive interface, which may be of an IDE (Integrated Device Electronics) format, E-IDE (Enhanced-IDE) format, ATA (Advanced Technology Attachment) format, or ATAPI (ATA Packet Interface) format. In addition, the I/O control circuit 24 can be a super I/O chip with one or more GPIO (General-Purpose Input Output) ports used as I/O ports for connecting one or more externally connecting storage devices 20. Lastly, the system control circuit 26 can be, for example, a south bridge chip.

Referring to FIG. 3, a flow chart schematically illustrates an interrupt service sequence implemented according to an embodiment of the invention. At step 30, the central processing unit 29 determines whether the interrupt request signal 260 is caused by a change in the connection status between the I/O control circuit 24 and the externally connecting storage devices 20. If yes, step 32 is executed, otherwise step 34 is executed. At step 32, according to the current number of connected storage devices 20 and their corresponding configuration association, the central processing unit 29 loads the corresponding interface settings into the interface control circuit 28. The interrupt service sequence ends at step 34.

A more detailed description in respect of step 32 is now provided. According to its internally stored interface settings, the interface control circuit 28 adequately and correctly controls the transmission format and the interface format of the connection interface 22, these interface settings being determined and differing according to the different numbers and types of storage devices 20. According to an embodiment, for different configuration associations of the storage devices 20, the content of the interface control circuit 28 may be read via a PCI tool program or I/O tool program in the operating system. Then an inquiry table is arranged and put in the interrupt service rule (ISR). Thereby, when the central processing unit 29 executes step 32, it will look up the inquiry table according to the number of storage devices 20 currently connected with the I/O control circuit 24 and their configuration association to find the corresponding interface settings, which it will then load into the interface control circuit 28 to obtain correct control.

Therefore, the technical method of the invention can use the BIOS to reconfigure the function settings of the chips of the computer system without the need to change the current computer system structure or restart the hardware. Via the association of appropriate ISR software to execute the interruption service sequence of the invention (as shown in FIG. 3), a system capable of using hot plug storage devices can be achieved. The production cost of the invention therefore is relatively lower and more easily practiced. Provided with hot plug functionality, such a storage device may be directly connected or removed while the computer system is turned on and in operation; the invention therefore enables convenient use without the need of turning off the computer system and opening the host casing to place the storage device. In addition, the invention is compatible with a plug-and-play system. As soon as the storage device is installed, the operating system will automatically detect its presence and consequently load appropriate interface settings. The user then can readily access data. With the hot plug functionality, the user further can conveniently replace, upgrade, and expand the storage device.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A computer system for dynamically accessing externally connecting storage devices, for allowing one or more of the storage devices to be dynamically connected to or separated from the computer system via a hot plug connection, the computer system comprising:
a connection interface connected with the one or more storage devices;
an input/output (I/O) control circuit for being connected with or separated from the one or more storage devices, wherein the I/O control circuit outputs an informing signal when a connection status between the one or more storage devices and the I/O control circuit changes;
a system control circuit connected with the I/O control circuit, for receiving the informing signal from the I/O control circuit and consequently outputting an interrupt request signal;
an interface control circuit connected with the connection interface, for controlling a transmission format and an interface format of the connection interface according to internally stored interface settings in the interface control circuit; and
a central processing unit connected with the connection interface and the system control circuit, for accessing the one or more storage devices via the connection interface, and for receiving the interrupt request signal from the system control circuit to consequently determine if the interrupt request signal corresponds to a change of the connection status between the I/O control circuit and the one or more storage devices, wherein if yes, the central processing unit loads corresponding interface settings into the interface control circuit according to the number and arrangement of the one or more storage devices connected to the I/O control circuit.

2. The computer system of claim 1, wherein the computer system is a storage server system.

3. The computer system of claim 1, wherein the I/O control circuit is a super I/O chip.

4. The computer system of claim 1, wherein the system control circuit is a south bridge chip.

5. The computer system of claim 1, wherein the externally connecting storage device is a storage device having large capacity.

6. The computer system of claim 3, wherein the I/O control circuit has one or more I/O ports for being connected with the storage devices.

7. The computer system of claim 5, wherein the storage device having large capacity is a disk drive.

8. The computer system of claim 6, wherein the I/O port is a GPIO (General-Purpose Input Output) port.

9. The computer system of claim 7, wherein the connection interface is a disk drive interface.

10. The computer system of claim 9, wherein the disk drive interface is of a format selected from the group consisting of IDE (Integrated Device Electronics) format, E-IDE (Enhanced-IDE) format, ATA (Advanced Technology Attachment) format, and ATAPI (ATA Packet Interface) format.
